(19) United States
(12) Patent Application Publication
(10) Pub. No.: US 2015/0184798 A1
(43) Pub. Date: Jul. 2, 2015

(54) Collapsible Strut Construction

(71) Applicant: CESA, Compañía Española de Sistemas Aeronáuticos, S.A., Getafe (ES)

(72) Inventors: Esteban Morante López, Getafe (ES); Eduardo Chamorro González-Tablas, Getafe (ES)

(21) Appl. No.: 14/580,994

(22) Filed: Dec. 23, 2014

(30) Foreign Application Priority Data
Dec. 26, 2013 (EP) 13382558.8

(51) Int. Cl. F16M 13/02

(52) U.S. Cl. CPC F16M 13/02

(57) ABSTRACT

A collapsible strut construction, manually movable between an extended, locked position and a retracted, unlocked position, with at least an outer tubular strut, an inner tubular strut slidable within the outer tubular strut and a pull-rotation mechanism configured to lock and unlock under load the outer tubular strut and the inner tubular strut together in the extended position. The pull-rotation mechanism has at least a plurality of locking dogs, a locking groove configured to house the plurality of locking dogs in the extended, locked position, an elastic member and a locking collar slidable and rotatable within the outer tubular strut and around the inner tubular strut, having the locking collar a crenel end with a plurality of cutouts.

### CROSS-REFERENCE TO RELATED APPLICATION

This application claims the benefit of European Patent Application No. 13382558.8 filed on Dec. 26, 2013, the entire contents of which are hereby incorporated herein by reference.

### BACKGROUND OF THE INVENTION

The present invention refers to a collapsible strut construction, manually movable between an extended, locked position and a retracted, unlocked position.

A plurality of collapsible strut constructions have been employed over past years for supporting aircraft cowlings in an open position as, for example, during maintenance operations of the engines.

As aircraft cowlings tend to be hefty, especially those covering large aircraft engines, and their weight can amount to hundreds of kilograms, an inadvertent unlocking of the collapsible strut construction in its extended, locked position results in a rapid, unpredictable closure of the aircraft cowling that may result in serious injury or even death of an operator performing maintenance operations of the engine beneath the aircraft cowling.

Different solutions aimed at preventing an inadvertent unlocking of the collapsible strut construction in its extended, locked position comprise unlocking sequences that may be manually performed when the collapsible strut construction is under load in its extended, locked position.

Simple unlocking sequences typically consist of an axial relative movement between the strut members. The problem with these collapsible strut constructions is that they are subject to inadvertent unlocking upon bumping or jarring of the strut members or of the aircraft cowling.

More complex unlocking sequences are safer against inadvertent unlocking of the collapsible strut construction. The problem with these collapsible strut constructions is that, since locking in the extended, locked position of the collapsible strut constructions implies performing these unlocking sequences in reverse order, they are tougher to correctly lock, which can result in an unnoticed incorrect locking of the collapsible strut construction in the extended, locked position.

### SUMMARY OF THE INVENTION

It is therefore an object of the present invention to provide a collapsible strut construction that requires an ordered unlocking sequence to ensure voluntary unlocking of the collapsible strut construction under load in the extended, locked position, while requiring an axial relative movement between the strut members to lock the collapsible strut construction in the extended, locked position.

This object is achieved with a collapsible strut construction, manually movable between an extended, locked position and a retracted, unlocked position, with at least an outer tubular strut, an inner tubular strut slidable within the outer tubular strut and a pull-rotation mechanism configured to lock and unlock under load the outer tubular strut and the inner tubular strut together in the extended position.

The pull-rotation mechanism has at least a plurality of locking dogs, a locking groove configured to house the plurality of locking dogs in the extended, locked position, elastic means (member) and a locking collar slidable and rotatable within the outer tubular strut and around the inner tubular strut, having the locking collar a crenel end with a plurality of cutouts.

Locking of the collapsible strut construction in its extended, locked position is performed by means of an axial relative movement between the outer tubular strut and the inner tubular strut as the locking collar and the elastic means (member) are configured to cooperatively bias the plurality of locking dogs into the locking groove.

Unlocking of the collapsible strut construction in its extended, locked position is performed by compressing the elastic means (member) and aligning the cutouts of the crenel end with each one of the locking dogs. In other words, the elastic means (member) is compressed and the cutouts of the crenel end are aligned with each one of the locking dogs in the extended, unlocked position.

### BRIEF DESCRIPTION OF THE DRAWINGS

FIG. 1 shows a collapsible strut construction in the extended, locked position according to a preferred embodiment of the invention.

FIG. 2 shows a collapsible strut construction in the retracted, unlocked position according to a preferred embodiment of the invention.

FIG. 3 is a sectional longitudinal view of the collapsible strut construction depicted in FIG. 1.

FIG. 4 is a sectional longitudinal view of the collapsible strut depicted in FIG. 2.

FIG. 5 is a section taken on line A-A of FIG. 3.

FIG. 6 is a section taken on line B-B of FIG. 4.

### DETAILED DESCRIPTION OF THE PREFERRED EMBODIMENTS

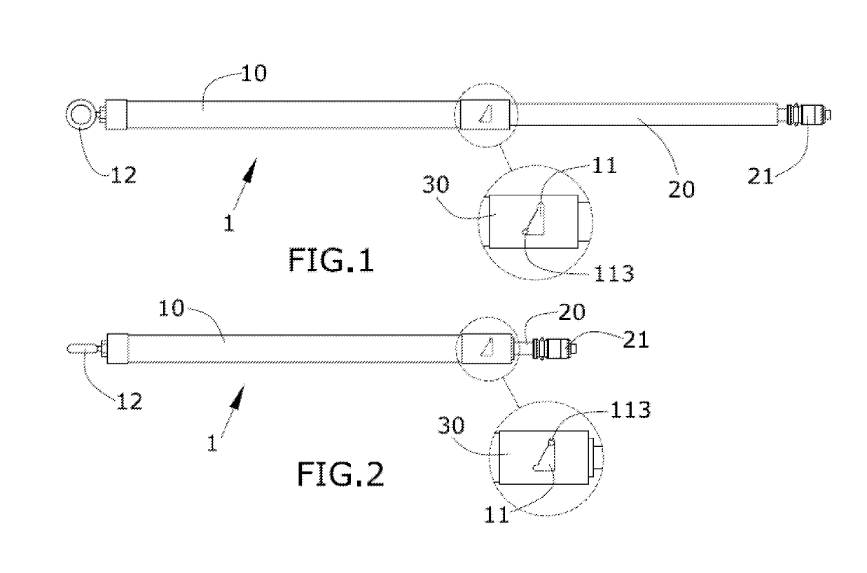

An embodiment of the present invention for a collapsible strut construction 1, manually movable under load from an extended, locked position (see FIG. 1) to a retracted, unlocked position (see FIG. 2) will be described hereinafter.

FIG. 1 shows the collapsible strut construction 1 in the extended, locked position wherein an outer tubular strut 10 and an inner tubular strut 20 are fully extended and locked at their proximal ends by means of a pull-rotation mechanism.

The distal end of the outer tubular strut 10 comprises a fastener 12 that rotatably couples the outer tubular strut 10 to a pivot fitting within a housing of underlying equipment, such as an engine, and the distal end of the inner tubular strut 20 comprises a detachable fastener 21 that may be detachably attached to one of a fitting of a cowling (not represented) for supporting the cowling in an open position and a stowage fitting (not represented) within the housing of the underlying equipment for stowing the collapsible strut construction 1.

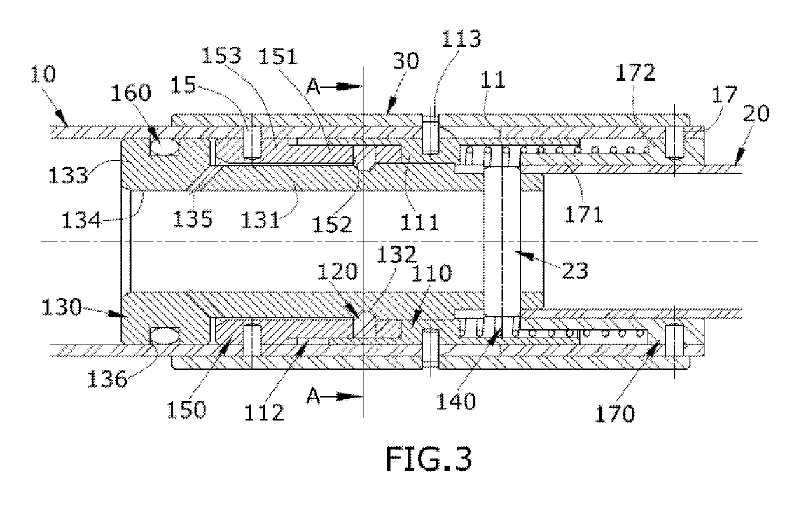

An embodiment of the pull-rotation mechanism will henceforth be described with reference to FIGS. 3 through 6. Herein, the pull-rotation mechanism comprises a locking collar 110, slidable and rotatable within the outer tubular strut 10 and around the inner tubular strut 20; a plurality of locking dogs 120; a piston 130, fastened to the inner tubular strut 20 and slidable within the outer tubular strut 10; elastic means (member) 140; a tubular cage 150, fastened to the outer tubular strut 10; a friction abutment 160 (see FIG. 3), configured to scrape the inner surface of the outer tubular strut 10; and a tubular end fitting 170, fastened to the outer tubular strut 10 and slidable around the inner tubular strut 20.

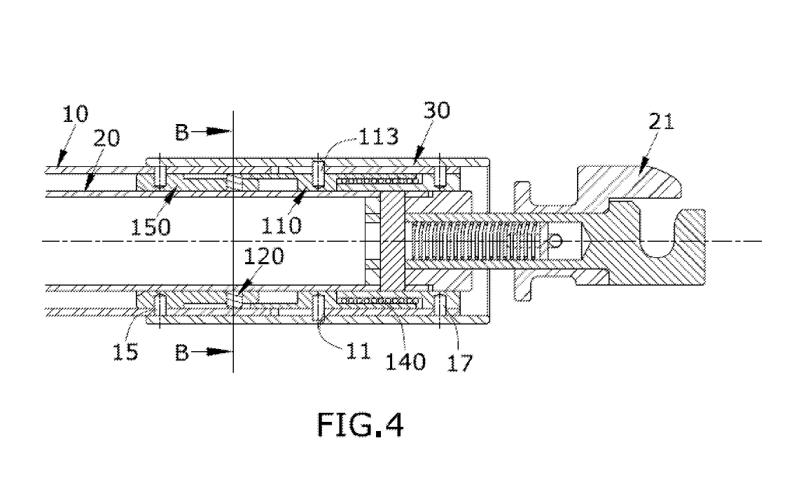

A possible embodiment of the elastic means (member) 140 has been represented in FIGS. 3 and 4. Therein it can be appreciated that the elastic means 140 (member) is a compression spring.

The locking collar 110 has an inner protrusion 111 configured to rest on the distal end of the elastic means (member) 140, and a crenel end 112 with a plurality of protrusions and a plurality of cutouts.

The elastic means (member) 140 surround a head portion 171 of reduced outer diameter of the tubular end fitting 170, which is fastened to the proximal end of the outer tubular strut 10 at an end abutment 172 by fastening means (members) 17, such that the head portion 171 is positioned farther within the outer tubular strut 10 than the end abutment 172.

Optionally, the proximal end of the elastic means (member) 140 may be coupled to the end abutment 172 of the tubular end fitting 170.

The locking collar 110 and the elastic means (member) 140 are configured to cooperatively bias the plurality of locking dogs 120 into a locking groove 132 configured to house the plurality of locking dogs 120 in the locked position.

The locking groove 132 is comprised in a head portion 131 of reduced outer diameter of the piston 130, which is fastened to the proximal end of the inner tubular strut 20 at an end abutment 133 by fastening means (members) 23, such that the end abutment 133 is positioned farther within the outer tubular strut 10 than the head portion 131. The head portion 131 is slidable within the tubular cage 150, whereas the end abutment 133 is slidable within the outer tubular strut 10.

A possible embodiment of the fastening means (members) 23 has been represented in FIG. 3. Therein it can be appreciated that the outer diameter of the end portion of the head portion 131 has been reduced to form an abutted junction with the proximal end of the inner tubular strut 20. Furthermore, the abutted junction is secured by a pin.

Optionally, the piston 130 may comprise a longitudinal bore 134 that results in a considerable weight reduction of the pull-rotation mechanism 100.

Another optional possibility is that the piston 130 comprises an anti-void cavity 135 (see FIG. 3) that prevents a vacuum from being established between the piston 130 and one of the outer tubular strut 10 and the tubular cage 150.

Each one of the plurality of locking dogs 120 are guided into and out of the locking groove 132 by means of one of a plurality of guiding slots 152 comprised in the tubular cage 150.

In this embodiment of the pull-rotation mechanism, the plurality of guiding slots 152 are comprised in a head portion 151 of reduced outer diameter of the tubular cage 150, which is fastened proximate to the proximal end of the outer tubular strut 10 at an end abutment 153 by fastening means (members) 15, such that the end abutment 153 is positioned farther within the outer tubular strut 10 than the head portion 151. The crenel end 112 of the locking collar 110 is slidable around the head portion 151 of the tubular cage 150.

When the detachable fastener 21 is detached from the stowage fitting of the housing of the underlying equipment, the inner tubular strut 20 is free to slide within the outer tubular strut 10 as the pull-rotation mechanism 100 is unlocked in this position.

In order to prevent this free sliding of the inner tubular strut 20 within the outer tubular strut 10, the end abutment 133 of the piston 130 comprises a friction groove 136 housing the friction abutment 160, which is configured to scrape the inner surface of the outer tubular strut 10.

In this embodiment, the collapsible strut construction 1 comprises an unlocking collar 30 slidable and rotatable around the outer tubular strut 10 and coupled to the pull-rotation mechanism 100 by means of a plurality of pins 113 comprised in the locking collar 110, the pins 113 projecting outwards of the locking collar 110 and each pin 113 traversing one of a plurality of recesses comprised in the outer tubular member 10.

The plurality of recesses comprised in the outer tubular member 10 are in this embodiment fluke-shaped slots 11 (see FIGS. 1 and 2). Each one of the plurality of fluke-shaped slots 11 are configured to guide one of the plurality of pins 113 from the extended, locked position to the extended, unlocked position and vice versa.

When the cowling is opened for service or maintenance operations, the collapsible strut construction 1 is stowed within the housing of the underlying equipment in its retracted, unlocked position (see FIG. 2) and the detachable fastener 21 is attached to the stowage fitting (not represented). This retracted, unlocked position reduces the load transfer between the fastener 12 and the detachable fastener 21 while the collapsible strut construction 1 is stowed as the pull-rotation mechanism is unlocked. Furthermore, this retracted, unlocked position reduces the modification of the cowling's stiffness.

As can be appreciated in FIG. 4, in the retracted, unlocked position the elastic means (member) 140 are compressed between the inner protrusion 111 of the locking collar 110 and the end abutment 172 of the tubular end fitting 170. The elastic means (member) 140 cannot return to their resting position as the locking dogs 120 block the movement of the locking collar 110, which in turn blocks the extension of the elastic means (member) 140.

In order to secure the cowling in its open position, first the detachable fastener 21 is detached from the stowage fitting of the housing and then the inner tubular strut 20 is pulled out from the outer tubular strut 10. Throughout the extension of the inner tubular strut 20, the locking dogs 120 slide around the inner tubular strut 10 while blocking the extension of the elastic means (member) 140.

When the inner tubular strut 20 reaches the extended position, the locking dogs 120 meet the locking groove 132, hence unblocking the movement of the locking collar 110, which in turn unblocks the extension of the elastic means (member) 140.

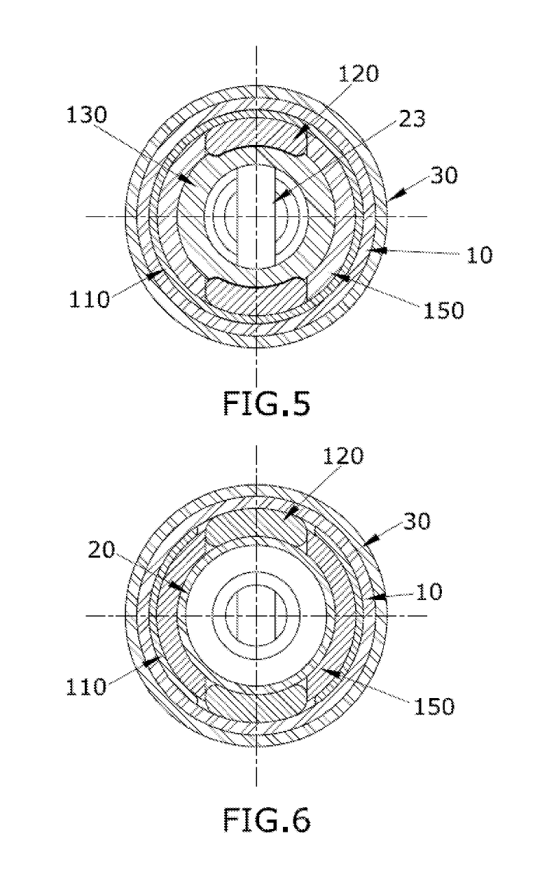

Upon extension of the elastic means (member) 140, the locking collar 110 advances farther within the outer tubular strut 10, abutting the locking dogs 120 in engagement with the locking groove 132 as represented in FIGS. 3 and 5.

This advancement of the locking collar 110 also comprises a rotating movement as the pins 113 are guided by the fluke-shaped slots 11 in a diagonal direction. This causes in turn the alignment of the plurality of protrusions of the crenel end 112 with each one of the plurality of locking dogs 120.

Now the pull-rotation mechanism is locked (see FIGS. 3 and 5), hence the outer tubular strut 10 and the inner tubular strut 20 are locked together in the extended position (see FIG. 1).

At this point, the detachable fastener 21 is attached to the fitting of the cowling to secure the cowling in the open position. With the collapsible strut construction 1 extended, locked and attached to the cowling, any operation on the underlying equipment may be carried out safely.

Another possibility for securing the cowling in its open position is to attach the detachable fastener 21 to the fitting of the cowling before pulling out the inner tubular strut 20 from the outer tubular strut 10.

Once the operations on the underlying equipment have been accomplished, unlocking of the collapsible strut construction 1 may be performed under load to close the cowling.

In this embodiment, this unlocking operation is performed by means of pulling and rotating the unlocking collar 30 as will be explained henceforth.

First, the unlocking collar 30 is pulled from the outer tubular strut 10 towards the inner tubular strut 20. In other words, the unlocking collar 30 is pulled towards the proximal end of the outer tubular strut 10.

The plurality of pins 113 slide against the longitudinal portion of the fluke-shaped grooves 11 upon pulling of the unlocking collar 30, which in turn guides the unlocking collar 30 while sliding around the outer tubular strut 10.

As the unlocking collar 30 is coupled to the locking collar 110 of the pull-rotation mechanism by means of the pins 113, pulling of the unlocking collar 30 results in the advancement of the locking collar 110 towards the proximal end of the outer tubular strut 10, which in turn compresses the elastic means (member) 140 between the inner protrusion 111 of the locking collar 110 and the end abutment 172 of the tubular end fitting 170.

In this embodiment, the advancement of the unlocking collar 30 is limited by both the rim of the head portion 171 of the tubular end fitting 170 that abuts the inner protrusion 111 of the locking collar 110 and the base portion of the fluke-shaped grooves 11 that abut each one of the pins 113.

The collapsible strut construction 1 has not yet been unlocked as the plurality of protrusions of the crenel end 112 of the locking collar 110 are aligned with each one of the plurality of locking dogs 120. In this position, the plurality of protrusions of the crenel end 112 abut one of the plurality of locking dogs 120 in engagement with the locking groove 132.

Next, the unlocking collar 30 is rotated around the outer tubular strut 10 until the position of engagement of the locking dogs 120 with the locking groove 132 is shifted to a position of release of the locking dogs 120 from the locking groove 132.

The plurality of pins 113 slide against the base portion of the fluke-shaped grooves 11 upon rotation of the unlocking collar 30, which in turns guides the unlocking collar 30 while rotating around the outer tubular strut 10.

As the unlocking collar 30 is coupled to the locking collar 110 of the pull-rotation mechanism by means of the pins 113, rotation of the unlocking collar 30 results in rotation of the locking collar 110.

In this embodiment, rotation of the unlocking collar 30 is limited by the tail portion of the fluke-shaped grooves 11 that abut each one of the pins 113.

Once the unlocking collar 30 has been fully rotated, the locking dogs 120 become aligned with each one of the plurality of protrusions 114 of the crenel end 112 of the locking collar 110. In this position, the locking dogs 120 are not abutted against the locking groove 132 so the pull-rotation mechanism becomes unlocked and abridgement of the collapsible strut construction 1 is possible.

Upon unlocking of the pull-rotation mechanism 100, the inner tubular strut 20 may be pushed within the outer tubular strut 10. Throughout the abridgement of the inner tubular strut 20, the locking dogs 120 slide around the inner tubular strut 10 while blocking the extension of the elastic means (member) 140.

When the inner tubular strut 20 reaches the retracted position, the detachable fastener 21 is detached from the fitting of the cowling and secured to the stowage fitting of the housing, thus allowing closure of the cowling.

As is apparent from the foregoing specification, the invention is susceptible of being embodied with various alterations and modifications which may differ particularly from those that have been described in the preceding specification and description. It should be understood that Applicant(s) wish to embody within the scope of the patent warranted hereon all such modifications as reasonably and properly come within the scope of the contribution to the art.

1. A collapsible strut construction, manually movable between an extended, locked position and a retracted, unlocked position, comprising:
an outer tubular strut;
an inner tubular strut slidable within the outer tubular strut; and
a pull-rotation mechanism configured to lock and unlock under load the outer tubular strut and the inner tubular strut together in the extended position, the pull-rotation mechanism further comprising a plurality of locking dogs, a locking groove configured to house the plurality of locking dogs in the extended, locked position, and an elastic member;
wherein the pull-rotation mechanism further comprises a locking collar slidable and rotatable within the outer tubular strut and around the inner tubular strut;
wherein the locking collar further comprises a crenel end having a plurality of cutouts;
wherein the locking collar and the elastic member are configured to cooperatively bias the plurality of locking dogs into the locking groove; and
wherein that the elastic member is compressed and the cutouts of the crenel end are aligned with each one of the locking dogs in the extended, unlocked position.

2. The collapsible strut construction according to claim 1, further comprising an unlocking collar slidable and rotatable around the outer tubular strut and coupled to the pull-rotation mechanism via a plurality of pins comprised in the locking collar, the pins projecting outwards of the locking collar and each pin traversing one of a plurality of recesses comprised in the outer tubular member.

3. The collapsible strut construction according to claim 2, wherein the plurality of recesses comprised in the outer tubular member are fluke-shaped slots, and wherein each one of the plurality of fluke-shaped slots is configured to guide one of the plurality of pins from the extended, locked position to the extended, unlocked position and vice versa.

4. The collapsible strut construction according to claim 1, wherein the pull-rotation mechanism further comprises a tubular cage fastened to the outer tubular strut by fastening members, the tubular cage further comprising a plurality of guiding slots, wherein each one of the plurality of guiding slots is configured to guide one of the plurality of locking dogs into and out of the locking groove.

5. The collapsible strut construction according to claim 4, wherein the tubular cage further comprises a head portion of reduced outer diameter and an end abutment fastened to the outer tubular strut by fastening members, such that the end abutment is positioned farther within the outer tubular strut than the head portion; the plurality of guiding slots are located in the head portion; and wherein the crenel end of the locking collar is slidable around the head portion of the tubular cage.

6. The collapsible strut construction according to claim 1, wherein the pull-rotation mechanism further comprises a piston slidable within the outer tubular strut and fastened to the inner tubular strut by fastening members, wherein the piston comprises the locking groove.

7. The collapsible strut construction according to claim 6, wherein the piston further comprises a friction groove housing a friction abutment configured to scrape the inner surface of the outer tubular strut.

8. The collapsible strut construction according to claim 6, wherein the piston further comprises a longitudinal bore.

9. The collapsible strut construction according to claim 6, wherein the piston further comprises an anti-void cavity.

10. The collapsible strut construction according to claim 1, wherein the pull-rotation mechanism further comprises a tubular end fitting slidable around the inner tubular strut; the tubular end fitting further comprising a head portion of reduced outer diameter and an end abutment fastened to the outer tubular strut by fastening members, such that the head portion is positioned farther within the outer tubular strut than the end abutment; and wherein the elastic member surrounds the head portion of the tubular end fitting.

11. The collapsible strut construction according to claim 10, wherein the proximal end of the elastic member is coupled to the end abutment of the tubular end fitting.

12. The collapsible strut construction according to claim 1, wherein the distal end of the outer tubular strut comprises one of a fastener or a detachable fastener.

13. The collapsible strut construction according to claim 1, wherein the distal end of the inner tubular strut comprises one of a fastener or a detachable fastener.

14. The collapsible strut construction according to claim 2, wherein the pull-rotation mechanism further comprises a tubular cage fastened to the outer tubular strut by fastening members, the tubular cage further comprising a plurality of guiding slots, wherein each one of the plurality of guiding slots is configured to guide one of the plurality of locking dogs into and out of the locking groove.

15. The collapsible strut construction according to claim 2, wherein the pull-rotation mechanism further comprises a piston slidable within the outer tubular strut and fastened to the inner tubular strut by fastening members, wherein the piston comprises the locking groove.

16. The collapsible strut construction according to claim 7, wherein the piston further comprises a longitudinal bore.

17. The collapsible strut construction according to claim 7, wherein the piston further comprises an anti-void cavity.

18. The collapsible strut construction according to claim 8, wherein the piston further comprises an anti-void cavity.

19. The collapsible strut construction according to claim 2, wherein the pull-rotation mechanism further comprises a tubular end fitting slidable around the inner tubular strut; the tubular end fitting further comprising a head portion of reduced outer diameter and an end abutment fastened to the outer tubular strut by fastening members, such that the head portion is positioned farther within the outer tubular strut than the end abutment; and wherein the elastic member surrounds the head portion of the tubular end fitting.

20. The collapsible strut construction according to claim 2, wherein the distal end of the outer tubular strut comprises one of a fastener or a detachable fastener.
